(19) United States
(12) Patent Application Publication
(10) Pub. No.: US 2022/0172259 A1
(43) Pub. Date: Jun. 2, 2022

(54) SMART DESTINATION SUGGESTIONS FOR A TRANSPORTATION SERVICE

(71) Applicant: WAYMO LLC, Mountain View, CA (US)

(72) Inventors: Salil Pandit, Palo Alto, CA (US); Guilherme Villar, San Francisco, CA (US); Lauren Schwendimann, Burlingame, CA (US); Ryan Powell, San Francisco, CA (US)

(73) Assignee: WAYMO LLC, Mountain View, CA (US)

(21) Appl. No.: 17/109,884

(22) Filed: Dec. 2, 2020

(51) Int. Cl. G06Q 30/02; G06Q 30/06; G06Q 50/30; H04W 4/02

(52) U.S. Cl. CPC G06Q 30/0282; G06Q 30/0631; H04W 4/025; G06Q 50/30; G06Q 30/0639

(57) ABSTRACT

Aspects of the disclosure relate to providing suggested locations for a trip using a transportation service. In one example, information for an initial destination location for a trip may be received from a client computing device. That the initial destination location is unavailable for the trip may be determined. One or more attributes may be identified based on the information. A search may be conducted for a plurality of suggested locations having attributes in common with the one or more identified attributes. The plurality of suggested locations may be ranked. The one or more of the plurality of suggested locations may be provided for display on the client computing devices to a user based on the ranking.

### BACKGROUND

Autonomous vehicles, for instance, vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location. Thus, such vehicles may be used to provide transportation services.

Other systems which provide transportation services typically include drivers or conductors who are tasked with making decisions about how to operate vehicles. Such services may include some backend server systems which can dispatch vehicles to certain locations to provide transportation services as well as provide fleet management and other operational functions.

### BRIEF SUMMARY

Aspects of the disclosure provide a method of providing suggested locations for a trip using a transportation service. The method includes receiving, by one or more server computing devices, from a client computing device information for an initial destination location for a trip; determining, by the one or more server computing devices, that the initial destination location is unavailable for the trip; identifying, by the one or more server computing devices, one or more attributes based on the information; conducting, by the one or more server computing devices, a search for a plurality of suggested locations having attributes in common with the one or more identified attributes; ranking, by the one or more server computing devices, the plurality of suggested locations; and providing, by the one or more server computing devices, one or more of the plurality of suggested locations for display on the client computing devices to a user based on the ranking.

In one example, the information identifies an item. In another example, the information identifies the initial destination location by a business name. In another example, the information identifies a type of business. In another example, determining that the initial destination location is not available is based on whether the initial destination location is within a service area of the transportation service. In another example, determining that the initial destination location is not available is based on whether a time for the trip would be outside of business hours for a business at the initial destination location. In another example, determining that the initial destination location is not available is based on whether the information is specific enough to identify a particular business location. In another example, the one or more attributes include terms input for the initial destination location by the user. In another example, the one or more attributes are identified by looking up the initial destination location in a location database. In another example, the one or more attributes includes text used in feedback descriptions for the initial destination location. In another example, the one or more attributes is determined from log data collected by autonomous vehicles. In another example, the ranking is based on the user's current location. In another example, the ranking is based on a future expected location for the user. In this example, the method also includes identifying the future expected location from calendar information of the user. In another example, the ranking is based on the user's trip history with the transportation service. In this example, the ranking is based on whether the user's trip history indicates that the user has taken a trip to any of the plurality of suggested locations. In addition or alternatively, the ranking is based on a number of times the user has taken a trip to any of the plurality of suggested locations identified in the user's trip history. In addition or alternatively, the ranking is based on whether the user's location history indicates that the user prefers one type of location over another type of location. In this example, the one type of location is a chain business and the another type of location is an independent business. In addition or alternatively, the ranking is based on an ease of picking up or dropping off passengers at any of the plurality of suggested locations. In addition or alternatively, the ranking is based on whether any of the plurality of suggested locations include a designated pickup or drop off area. In another example, providing the one or more of the plurality of suggested locations includes providing for display an indication of why the initial destination location is unavailable. In another example, providing the one or more of the plurality of suggested locations includes providing for display an indication of why the suggested location is provided.

### BRIEF DESCRIPTION OF THE DRAWINGS

FIG. 1 is a functional diagram of an example vehicle in accordance with an exemplary embodiment.

FIG. 2 is an example external view of a vehicle in accordance with aspects of the disclosure.

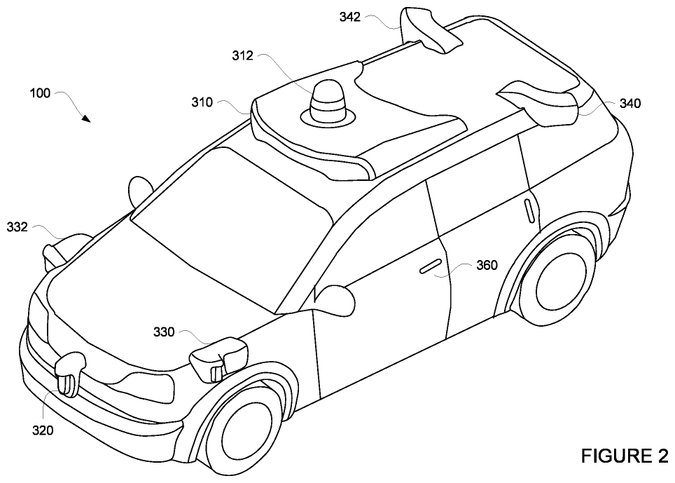

FIG. 3 is a pictorial diagram of an example system in accordance with aspects of the disclosure.

FIG. 4 is a functional diagram of the system of FIG. 4 in accordance with aspects of the disclosure.

FIG. 5 is an example client computing device and displayed information in accordance with aspects of the disclosure.

FIG. 6 is an example representation of a portion of data for a location database in accordance with aspects of the disclosure.

FIG. 7 is an example client computing device and displayed information in accordance with aspects of the disclosure.

FIG. 8 is an example client computing device and displayed information in accordance with aspects of the disclosure.

FIG. 9 is an example flow diagram in accordance with aspects of the disclosure.

### DETAILED DESCRIPTION

### Overview

The technology relates to providing suggested destinations to users of a transportation service. For example, a user may have a goal, such as an idea of a type of place, specific activity or a task the user would like to accomplish on a trip. However, it is not always clear where to go to accomplish the goal. While making suggestions based on historical (or even some cases real time data about local events, etc.) is a powerful retention strategy, such suggestions are often scoped too closely to the users existing behavior and do not end up expanding the user's interactions beyond a small set of places or popular activities or tasks. In order to address this, leveraging in-depth knowledge of types of places people visit and what time of day or day of the week they visit and in what context they visit, even more intelligent suggestions can be made.

For an example, a user may input an initial destination location for a trip into a client computing device via an application, and the application may send the initial destination location to one or more server computing devices. This information may be received by the server computing devices and used to determine whether the initial destination location is available. In the event that the initial destination location is determined to be not available, the server computing devices may attempt to identify one or more attributes.

Once the one or more attributes are identified for the initial destination location, the server computing devices may conduct a search of the location data base for one or more suggested locations. For example, the search may return all locations associated with the one or more attributes that are within a service area. The locations may then be ranked based on a plurality of different types of considerations.

The one or more highest ranked suggested locations may then be provided for display to the user. A user may then select a suggested location to find out more about that location and/or to set up a trip to that location. This may send a signal to the server computing devices, which in turn, may dispatch an autonomous vehicle to pick up the user and complete the trip. Dispatching may involve sending a signal to the autonomous vehicle identifying the location as a destination location for the trip as well as a pickup location for picking up the user. This, in turn, may causes the vehicle to automatically control itself to the pickup location and the destination location.

The features described herein may enable better recommendations for users of a transportation service. For example, when a particular requested location is unavailable for any reason, the user may be provided with high-quality suggested locations based on knowledge of the type of place, the time of day, and the context in which people visit such suggested locations. In addition, users may be more satisfied with the service while at the same time being encouraged to complete more trips.

### Example Systems

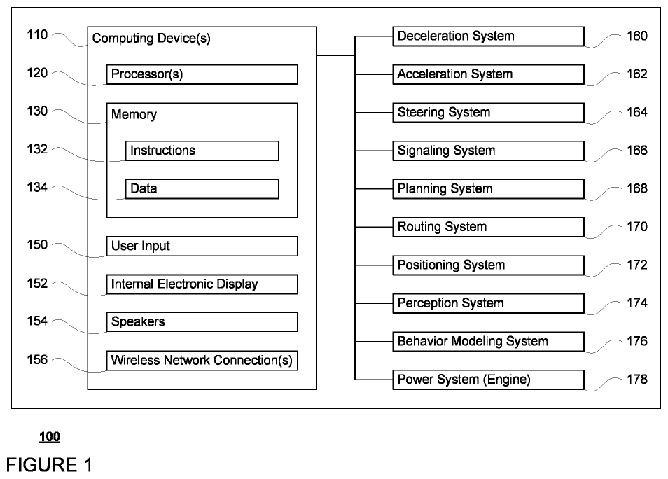

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 134 and data 132 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more button, mouse, keyboard, touch screen and/or microphone), various electronic displays (e.g., a monitor having a screen or any other electrical device that is operable to display information), and speakers 154 to provide information to a passenger of the vehicle 100 or others as needed. For example, electronic display 152 may be located within a cabin of vehicle 100 and may be used by computing devices 110 to provide information to passengers within the vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

The computing devices 110 may be part of an autonomous control system for the vehicle 100 and may be capable of communicating with various components of the vehicle in order to control the vehicle in an autonomous driving mode. For example, returning to FIG. 1, the computing devices 110 may be in communication with various systems of vehicle 100, such as deceleration system 160, acceleration system 162, steering system 164, signaling system 166, planning system 168, routing system 170, positioning system 172, perception system 174, behavior modeling system 176, and power system 178 in order to control the movement, speed, etc. of vehicle 100 in accordance with the instructions 134 of memory 130 in the autonomous driving mode.

As an example, the computing devices 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle. The computing devices 110 may also use the signaling system 166 in order to signal the vehicle's intent to other drivers or vehicles, for example, by lighting turn signals or brake lights when needed.

Routing system 170 may be used by the computing devices 110 in order to generate a route to a destination using map information. Planning system 168 may be used by computing device 110 in order to generate short-term trajectories that allow the vehicle to follow routes generated by the routing system. In this regard, the planning system 168 and/or routing system 166 may store detailed map information, e.g., highly detailed maps identifying a road network including the shape and elevation of roadways, lane lines, intersections, crosswalks, speed limits, traffic signals, buildings, signs, real time traffic information, pullover spots, vegetation, or other such objects and information.

In addition to the aforementioned physical feature information, the map information may include a plurality of graph nodes and edges representing road or lane segments that together make up the road network of the map information. Each edge is defined by a starting graph node having a specific geographic location (e.g. latitude, longitude, altitude, etc.), an ending graph node having a specific geographic location (e.g. latitude, longitude, altitude, etc.), and a direction. This direction may refer to a direction the vehicle 100 must be moving in in order to follow the edge (i.e. a direction of traffic flow). The graph nodes may be located at fixed or variable distances. For instance, the spacing of the graph nodes may range from a few centimeters to a few meters and may correspond to the speed limit of a road on which the graph node is located. In this regard, greater speeds may correspond to greater distances between graph nodes. The edges may represent driving along the same lane or changing lanes. Each node and edge may have a unique identifier, such as a latitude and longitude location of the node or starting and ending locations or nodes of an edge. In addition to nodes and edges, the map may identify additional information such as types of maneuvers required at different edges as well as which lanes are drivable.

The routing system 166 may use the aforementioned map information to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the vehicle, etc. Each route may include a list of a plurality of nodes and edges which the vehicle can use to reach the destination. Routes may be recomputed periodically as the vehicle travels to the destination.

The map information used for routing may be the same or a different map as that used for planning trajectories. For example, the map information used for planning routes not only requires information on individual lanes, but also the nature of lane boundaries (e.g., solid white, dash white, solid yellow, etc.) to determine where lane changes are allowed. However, unlike the map used for planning trajectories, the map information used for routing need not include other details such as the locations of crosswalks, traffic lights, stop signs, etc., though some of this information may be useful for routing purposes. For example, between a route with a large number of intersections with traffic controls (such as stop signs or traffic signal lights) versus one with no or very few traffic controls, the latter route may have a lower cost (e.g. because it is faster) and therefore be preferable.

Positioning system 170 may be used by computing devices 110 in order to determine the vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the vehicle. The location of the vehicle may include an absolute geographical location, such as latitude, longitude, and altitude, a location of a node or edge of the roadgraph as well as relative location information, such as location relative to other cars immediately around it which can often be determined with less noise that absolute geographical location.

The positioning system 172 may also include other devices in communication with the computing devices computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

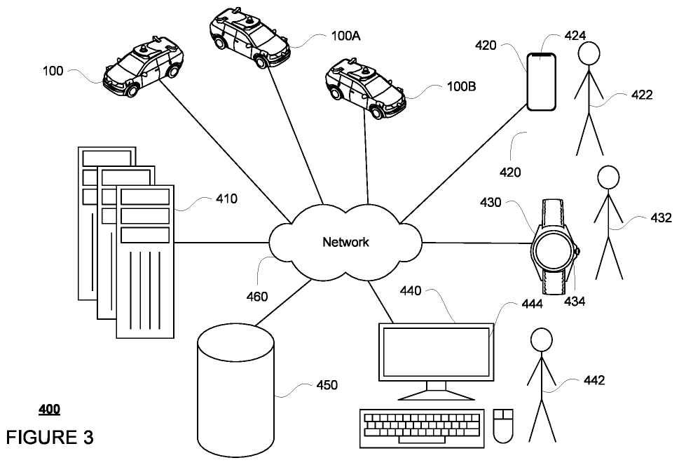

The perception system 174 also includes one or more components for detecting objects external to the vehicle such as other vehicles, obstacles in the roadway, traffic signals, signs, trees, etc. For example, the perception system 174 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location. For instance, FIG. 3 is an example external view of vehicle 100. In this example, roof-top housing 310 and dome housing 312 may include a LIDAR sensor as well as various cameras and radar units. In addition, housing 320 located at the front end of vehicle 100 and housings 330, 332 on the driver's and passenger's sides of the vehicle may each store a LIDAR sensor. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310.

The computing devices 110 may be capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as deceleration system 160, acceleration system 162, steering system 164, signaling system 166, planning system 168, routing system 170, positioning system 172, perception system 174, behavior modeling system 176, and power system 178 (i.e. the vehicle's engine or motor) in order to control the movement, speed, etc. of vehicle 100 in accordance with the instructions 134 of memory 130.

The various systems of the vehicle may function using autonomous vehicle control software in order to determine how to and to control the vehicle. As an example, a perception system software module of the perception system 174 may use sensor data generated by one or more sensors of an autonomous vehicle, such as cameras, LIDAR sensors, radar units, sonar units, etc., to detect and identify objects and their characteristics. These characteristics may include location, type, heading, orientation, speed, acceleration, change in acceleration, size, shape, etc. In some instances, characteristics may be input into a behavior prediction system software module of the behavior modeling system 176 which uses various behavior models based on object type to output a predicted future behavior for a detected object. In other instances, the characteristics may be put into one or more detection system software modules, such as a traffic light detection system software module configured to detect the states of known traffic signals, construction zone detection system software module configured to detect construction zones from sensor data generated by the one or more sensors of the vehicle as well as an emergency vehicle detection system configured to detect emergency vehicles from sensor data generated by sensors of the vehicle. Each of these detection system software modules may use various models to output a likelihood of a construction zone or an object being an emergency vehicle. Detected objects, predicted future behaviors, various likelihoods from detection system software modules, the map information identifying the vehicle's environment, position information from the positioning system 170 identifying the location and orientation of the vehicle, a destination location or node for the vehicle as well as feedback from various other systems of the vehicle may be input into a planning system software module of the planning system 168. The planning system 168 may use this input to generate trajectories for the vehicle to follow for some brief period of time into the future based on a route generated by a routing module of the routing system 170. In this regard, the trajectories may define the specific characteristics of acceleration, deceleration, speed, etc. to allow the vehicle to follow the route towards reaching a destination. A control system software module of the computing devices 110 may be configured to control movement of the vehicle, for instance by controlling braking, acceleration and steering of the vehicle, in order to follow a trajectory.

The computing devices 110 may control the vehicle in an autonomous driving mode by controlling various components. For instance, by way of example, the computing devices 110 may navigate the vehicle to a destination location completely autonomously using data from the detailed map information and planning system 168. The computing devices 110 may use the positioning system 170 to determine the vehicle's location and perception system 174 to detect and respond to objects when needed to reach the location safely. Again, in order to do so, computing device 110 and/or planning system 168 may generate trajectories and cause the vehicle to follow these trajectories, for instance, by causing the vehicle to accelerate (e.g., by supplying fuel or other energy to the engine or power system 178 by acceleration system 162), decelerate (e.g., by decreasing the fuel supplied to the engine or power system 178, changing gears, and/or by applying brakes by deceleration system 160), change direction (e.g., by turning the front or rear wheels of vehicle 100 by steering system 164), and signal such changes (e.g., by lighting turn signals) using the signaling system 166. Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

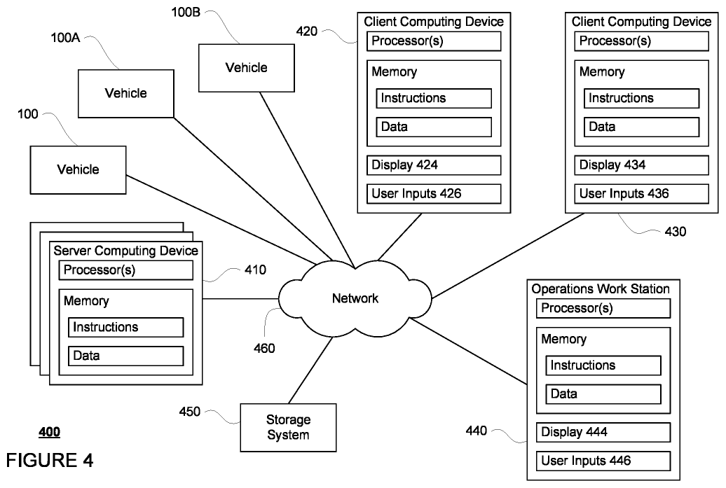

Computing device 110 of vehicle 100 may also receive or transfer information to and from other computing devices, such as those computing devices that are a part of the transportation service as well as other computing devices. FIGS. 3 and 4 are pictorial and functional diagrams, respectively, of an example system 400 that includes a plurality of computing devices 410, 420, 430, 440 and a storage system 450 connected via a network 460. System 400 also includes vehicle 100A and vehicle 100B, which may be configured the same as or similarly to vehicle 100. Although only a few vehicles and computing devices are depicted for simplicity, a typical system may include significantly more.

As shown in FIG. 4, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening graph nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of vehicle 100 or a similar computing device of vehicle 100A or vehicle 100B as well as computing devices 420, 430, 440 via the network 460. For example, vehicles 100, 100A, 100B, may be a part of a fleet of vehicles that can be dispatched by server computing devices to various locations. In this regard, the server computing devices 410 may function as a fleet management system which can be used to dispatch vehicles such as vehicles 100, 100A, 100B to different locations in order to pick up and drop off passengers. In addition, the computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 4, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, shown as a wristwatch as shown in FIG. 4. As an example the user may input information using a small keyboard, a keypad, microphone, using visual signals with a camera, or a touch screen.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 3 and 4, and/or may be directly connected to or incorporated into any of the computing devices 110, 410, 420, 430, 440, etc.

Storage system 450 may store various types of information as described in more detail below. This information may be retrieved or otherwise accessed by a server computing device, such as one or more server computing devices 410, in order to perform some or all of the features described herein. For instance, the storage system may store a location data base as discussed in further detail below.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

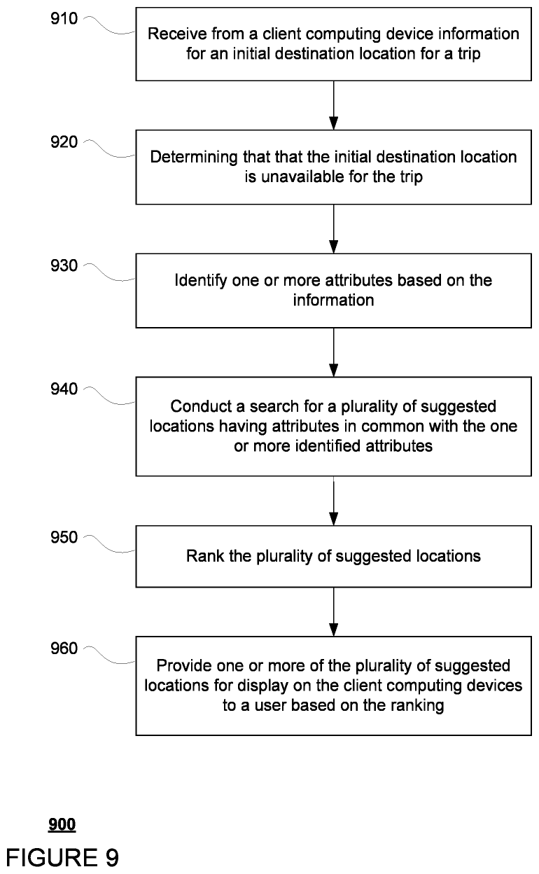

FIG. 9 is an example flow diagram 900 for providing suggested locations for a trip using a transportation service, which may be performed by one or more processors of one or more computing devices, such as the processors the server computing devices 410. At block 910, information for an initial destination location for a trip is received from a client computing device.

In one aspect, a user may download an application for requesting a vehicle to a client computing device. For example, users 422 and 432 may download the application via a link in an email, directly from a website, or an application store to client computing devices 420 and 430. For example, a client computing device may transmit a request for the application over the network, for example, to one or more server computing devices 110, and in response, receive the application. The application may be installed locally at the client computing device.

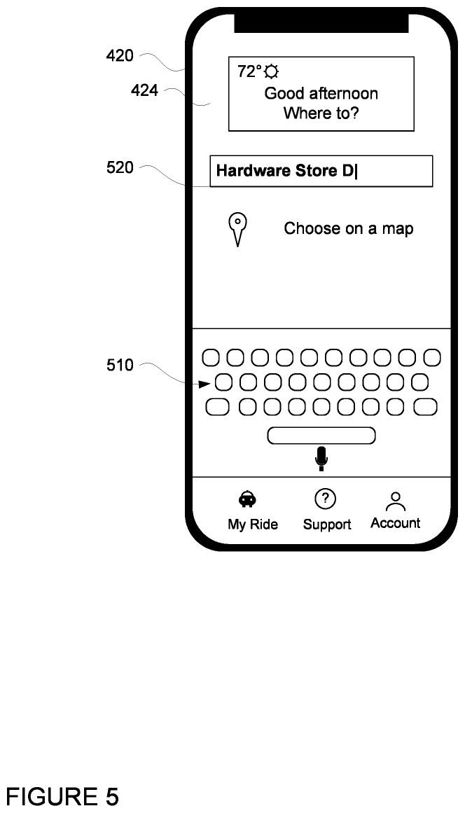

A user, such as user 422, may input an initial destination location for a trip into a client computing device, such as client computing device 420, via an application, and the application may send the initial destination location to one or more server computing devices 410. This initial destination location may be defined as an address, a name (e.g. a business name), a type of business (e.g. a hardware store), or some item (e.g. a type of good that is needed by the user such as “tools” or “paint”). For example, as depicted in FIG. 5, using the client computing device 420, a user may use a small keyboard 510 on the display 424 to enter an initial destination location using the name of a business, here “Hardware Store D”, into a field 520 displayed in the aforementioned application. The client computing device 420 may send information including the initial destination location to the server computing devices 410 via a network such as network 460.

The user may also specify or otherwise provide a pickup location at which a vehicle can pick up the vehicle. As an example, a pickup location can be defaulted to current location of the passenger's client computing device, but may also be a recent or saved location near the current location associated with the passenger's account. The passenger may enter an address or other location information, tap a location on a map or select a location from a list in order to identify a pickup location. For instance, the client computing device 420 may send its current location, such as a GPS location, to the one or more server computing devices 110 via network 460 and/or a destination name or address for the pickup location.

At block 920, that the initial destination location is unavailable for the trip is determined. The information including the initial destination location (and any other locations such as a pickup location and/or any intermediate destination locations) may be received by the server computing devices 410 and used to determine whether the initial destination location is available. As an example, an initial destination location may not be available if it is not within a service area for the transportation service, a time for the trip would be outside of operating hours (as determined from a location database discussed further below), or if the input information is not specific enough to identify one particular business location (e.g. “hardware store” or “paint”). As an example, the server computing devices 410 may determine that Hardware Store D is unavailable because it is currently closed, closing soon (e.g. before the user could reach the location), or outside of a service area for the transportation service.

At block 930, one or more attributes is identified based on the information. In the event that the initial destination location is determined to be not available, the server computing devices 410 may attempt to identify one or more attributes. These attributes may include any terms input for the initial destination location, such as “hardware store”, “tools”, “paint” etc. As another example, attributes may be determined by looking up a particular business in a location database, such as the aforementioned location database of storage system 450.

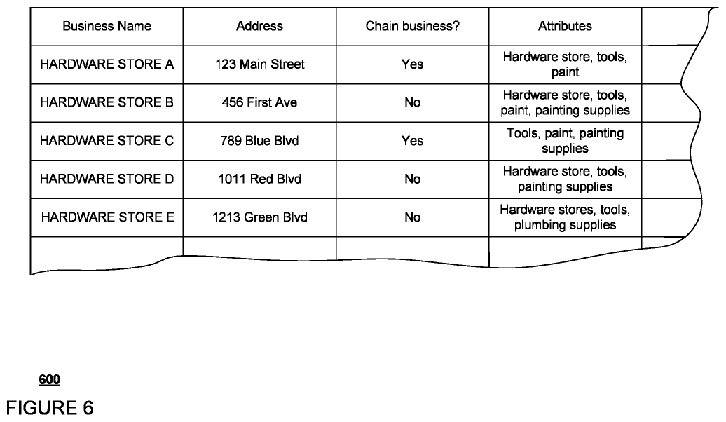

FIG. 6 is an example representation of a portion of data for a location database 600. In this example, the location database includes 5 businesses, HARDWARE STORE A, HARDWARE STORE B, HARDWARE STORE C, HARDWARE STORE D, and HARDWARE STORE D. Each of these businesses is associated with information identifying a location (e.g. an address) for the business as well as a list of attributes. For example, looking up “HARDWARE STORE A” may return attributes such as “hardware store”, “tools”, “paint”, etc. In addition, the location database may include other types of information about businesses such as details about ownership or corporate structure of the business such as whether the business is a chain business such as a corporate chain store, wholesaler, dealership or franchise (as shown in FIG. 6) and/or whether the business is an independent business or co-op. The details of the location database depicted in FIG. 6 are meant to be representative only, and various other types of businesses and information (e.g. hours, user reviews, etc.) may be included in a location database.

The location database may include any number of different sources of information. For example, some publicly available and private databases may store information or records about businesses such as their geographic location, highlights about what a business is known for such as offerings of goods and services, hours of operation, contact information, and user reviews. The offerings of goods and services as well as some content of user reviews (such as nouns commonly used in reviews) may be considered attributes. For example, “cocktails” or “coffee” or “tools” will be used frequently in the text of feedback descriptions. Attributes can also be determined from other sources, such as log data collected by autonomous vehicles. As an example, the log data may be analyzed to identify what types of objects users are loading into a vehicle after visiting a location.

In other instances, attributes may be “smeared” between different locations. For instance, by examining user searches and trips completed by users, the server computing devices may determine whether a user searches for one business and ends up at a different one instead. For example, if a user searches for a business called “COFFEE SHOP A”, but then confirms a trip to go to another business “COFFEE SHOP B”, these businesses may be considered similar enough to smear or copy the attributes from “COFFEE SHOP A” into the record for “COFFEE SHOP B”.

At block 940, a search for a plurality of suggested locations having attributes in common with the one or more identified attributes is conducted. Once the one or more attributes are identified for the initial destination location, the server computing devices 410 may conduct a search of the location database for one or more suggested locations. For example, the search may return all locations associated with the one or more attributes that are within a service area. Returning to the example of HARDWARE STORE D, the server computing devices may use the attributes “hardware store”, “tools” and “painting supplies” to identify HARDWARE STORE A, HARDWARE STORE B, HARDWARE STORE C, and HARDWARE STORE E as suggested locations as each of these businesses have at least one common attribute with HARDWARE STORE D. Other businesses that do not have at least one common attribute with HARDWARE STORE D may not be identified as a suggested location.

At block 950, the plurality of suggested locations are ranked. The server computing devices 410 may rank the locations returned from the search based on a plurality of different types of considerations. In this regard, the businesses identified in the search as suggested locations, HARDWARE STORE A, HARDWARE STORE B, HARDWARE STORE C, and HARDWARE STORE E, may be ranked.

As one instance, a user's current location may be used to rank those suggested locations that are closest to the user's current location. Similarly, suggested locations that are closest to a user's future expected location may be ranked higher than those that are farther from the user's expected future location. As an example, a user's future expected location may be determined from calendar information shared with the aforementioned application or alternatively may be determined based on the user's location history (or travel patterns) and/or trip history. For example, if in the evenings a user typically goes “home” after “work”, then if 2 suggested locations are equally distant from the user's current location of work, then a suggested location closer to the user's home may be ranked higher than other suggested locations that are farther from the user's home. In this regard, each user's location history (if the user provides access to this information) and/or trip history may be stored in the storage system 450.

As another instance, a user's trip history may be used to rank suggested locations, such that suggested locations where the user has already traveled to on a prior trip or more frequently may be ranked higher than others. Similarly, if a user typically makes more than one stop on a trip, suggested locations that are closest to the locations of those stops may be ranked higher than other suggested locations. In this regard, as noted above, each user's trip history may be stored in the storage system 450.

As another instance, if the user's trip history suggests that the user or other similarly situated users with similar trip histories prefers one type of location over another, suggested locations of that type may be ranked higher than other suggested locations. For example, if a user prefers one type of chain store over another or if the user prefers independent stores over chain stores, suggested locations corresponding to the former may be ranked higher over other suggested locations. In this regard, as noted above, each user's trip history may be stored in the storage system 450, and the server computing devices 410 may use the information as to whether a business is a chain business in a location database such as the location database 600. As an example, for a trip, a user's trip history may include information such as data, status (cancelled, taken, etc.), pickup and drop off locations, information identifying route taken during the trip and/or a visualization of the route on a map, distance of the trip, duration of the trip, cost (price paid by the user), user review (e.g. a star rating), number of passengers, whether there were any intermediate destinations between the pickup and drop off locations, etc.

As another instance, suggested locations may be ranked based on how pickup and drop off characteristics of those suggested locations. For example, suggested locations with a greater number of successful pickups and drop offs by autonomous vehicles may be ranked higher than those with a fewer number.

Similarly, suggested locations with lower expected congestion (e.g. traffic conditions) may be ranked higher than those with higher expected congestion.

As another instance, suggested locations with a dedicated pickup or drop off area may be ranked higher than those without.

As another example, suggested locations with quicker turnover of customers (e.g. a faster in-and-out time of a particular business) may be ranked higher than other suggested locations. For example, if a first coffee shop has an average time in-and-out of 2 minutes, whereas a second coffee shop nearby has an average in-and-out time of 10 minutes, this may be a meaningful difference for a user. As such, a suggested location for the first coffee shop may be ranked higher than the suggested location for the second coffee shop.

As another instance, suggested locations that are well-lit and busy (e.g. have high foot traffic) may be ranked higher when a user is requesting a trip at night. For example, outdoor lighting and foot traffic may be good indicators for perceived safety. As such, a user may prefer a bar or restaurant that is busy and bright at night over one that is dark and empty.

In other instances, how easy it would be for a vehicle to reach each suggested location may be used to rank the suggested locations. In this example, suggested locations that would require more complicated maneuvers, such as U-turns, unprotected turns, etc. may be ranked lower than other suggested locations.

Two or more of these ranking factors may be combined into a ranking scheme. An example ranking scheme may include, first ranking suggested locations based on a user's trip history, thereafter based upon the user's current location, thereafter based upon on how pickup and drop off characteristics, and finally based on whether a suggestion location is nearby to a future expected location that the user is likely to want to visit after visiting the suggested location.

At block 960, one or more of the plurality of suggested locations are provided for display on the client computing devices to a user based on the ranking. The one or more highest ranked suggested locations may be provided for display to the user. In this regard, the server computing devices 410 may send one or more of the highest ranked suggested locations via the network 460 to the client computing device 420 for display on display 424 to the user 422.

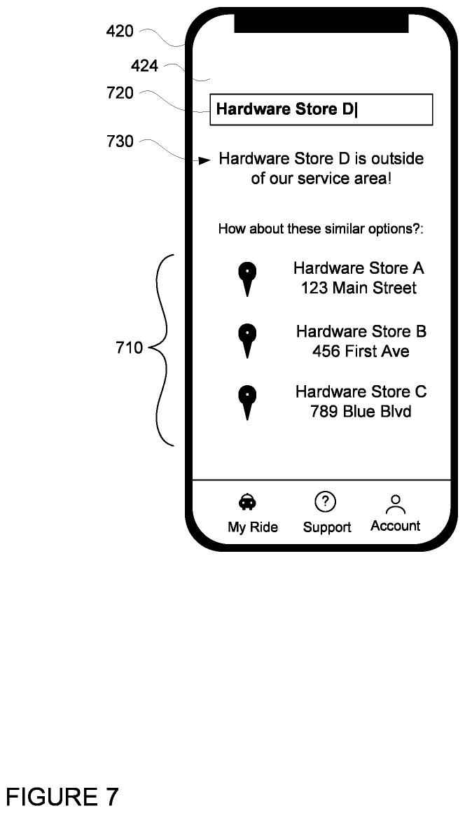

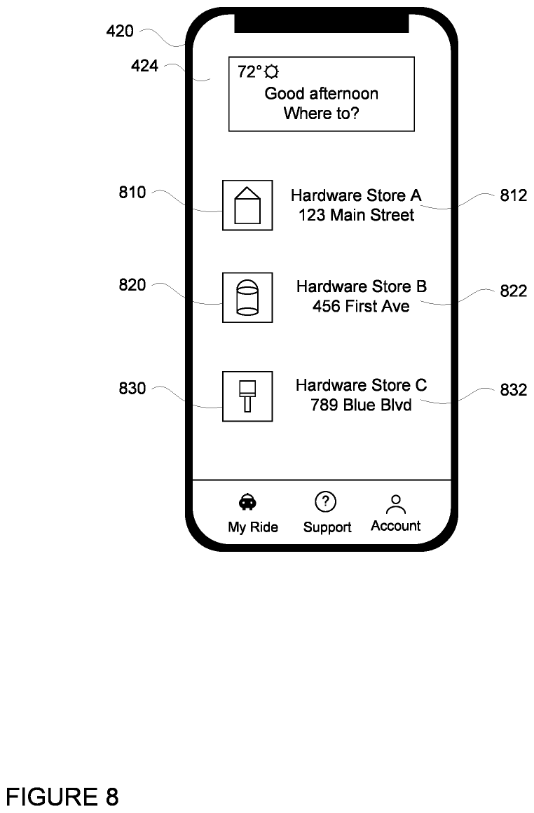

For example, the suggested locations may be displayed below a search box 710 as list 720 of potential search results as shown in FIG. 7 or alternatively with tiles 810, 820, 830 with (or without) descriptive information 812, 822, 832 for each tile as shown in FIG. 8. In addition to the search results, 5 information about why the initial destination location is not available may also be provided, such as that the initial destination location is outside of a service area (such as with notification 730 in FIG. 7) or is closing soon, or why the suggested location was provided, such as the suggested location is open till much later. In addition or alternatively, the suggested locations may be displayed on a map as map pins and/or an image of the suggested location (e.g. a street-level image or an interior image depending on what is available). Other information, such as store ratings (depicted as text and/or a set of stars) or reviews as well as whether the suggested location has a dedicated pickup or drop off area may also be provided.

The user 420 may then select a suggested location to find out more about that location and/or to set up a trip to the selected suggested location. This may cause the client computing device 420 to send a signal to the server computing devices 410, which in turn, may dispatch an autonomous vehicle to pick up the user 422 and complete the trip. Dispatching may involve sending a signal to the autonomous vehicle 100 identifying the selected suggested location as a destination location for the trip as well as a pickup location for picking up the user 422. This, in turn, may cause the vehicle to automatically control itself to the pickup location and the destination location autonomously (e.g. in an autonomous driving mode) as described above.

Alternatively, attributes may be determined prior to a user inputting any information. For example, using the user's trip history, the server computing devices 410 may identify attributes, and conduct a search for nearby locations that are currently available and have common attributes. In this regard, the suggested locations may change as the user's trip history, current time of day, and/or current day of the week changes.

Once a suggested location is provided, the server computing devices may track certain types of information in order to improve future suggestions to this and potentially other users. For example, the server computing devices 410 may track the click rate of the suggestion or how often users select a particular suggested location to find out more information. This may provide a signal of how good a suggested location was for the user. As another example, whether a user completes a trip to the suggested location may provide an even better signal as to how good a suggested location was for a user. As yet another example, a user may be asked to rank suggested locations, for example, by being prompted for a star or numerical rating (“How was this suggestion”?). As another example, whether a user does not complete the request for a trip may also be a signal as to how good a suggested location was for a user.

Such information may be helpful to both improving the attribute relationships as well as the rankings. For example, this data could be used to train the model on positive and negative examples. The model may be used to improve suggestions for a specific user and to help provide a signal on which attributes are most useful for the specific user to make a decision to accept a suggestion. In addition, the model may be used to help understand user interest and positive associations with certain attributes while also gaining a better understanding of the role of other trip attributes (cost, distance, time of arrival, etc.) on version if a user accepts a suggestion but later cancels a trip (e.g. does not complete the trip).

The features described herein may enable better recommendations for users of a transportation service. For example, when a particular requested location is unavailable for any reason, the user may be provided with high-quality suggested locations based on knowledge of the type of place, the time of day, and the context in which people visit such suggested locations. In addition, users may be more satisfied with the service while at the same time being encouraged to complete more trips.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of providing suggested locations for a trip using a transportation service, the method comprising:
receiving, by one or more server computing devices, from a client computing device information for an initial destination location for a trip;
determining, by the one or more server computing devices, that the initial destination location is unavailable for the trip;
identifying, by the one or more server computing devices, one or more attributes based on the information;
conducting, by the one or more server computing devices, a search for a plurality of suggested locations having attributes in common with the one or more identified attributes;
ranking, by the one or more server computing devices, the plurality of suggested locations; and
providing, by the one or more server computing devices, one or more of the plurality of suggested locations for display on the client computing devices to a user based on the ranking.

2. The method of claim 1, wherein the information identifies an item.

3. The method of claim 1, wherein the information identifies the initial destination location by a business name.

4. The method of claim 1, wherein the information identifies a type of business.

5. The method of claim 1, wherein determining that the initial destination location is not available is based on whether the initial destination location is within a service area of the transportation service.

6. The method of claim 1, wherein determining that the initial destination location is not available is based on whether a time for the trip would be outside of business hours for a business at the initial destination location.

7. The method of claim 1, wherein determining that the initial destination location is not available is based on whether the information is specific enough to identify a particular business location.

8. The method of claim 1, wherein the one or more attributes include terms input for the initial destination location by the user.

9. The method of claim 1, wherein the one or more attributes are identified by looking up the initial destination location in a location database.

10. The method of claim 1, wherein the one or more attributes includes text used in feedback descriptions for the initial destination location.

11. The method of claim 1, wherein the one or more attributes is determined from log data collected by autonomous vehicles.

12. The method of claim 1, wherein the ranking is based on the user's current location.

13. The method of claim 1, wherein the ranking is based on a future expected location for the user.

14. The method of claim 13, further comprising, identifying the future expected location from calendar information of the user.

15. The method of claim 1, wherein the ranking is based on the user's trip history with the transportation service.

16. The method of claim 15, wherein the ranking is based on whether the user's trip history indicates that the user has taken a trip to any of the plurality of suggested locations.

17. The method of claim 15, wherein the ranking is based on a number of times the user has taken a trip to any of the plurality of suggested locations identified in the user's trip history.

18. The method of claim 15, wherein the ranking is based on whether the user's location history indicates that the user prefers one type of location over another type of location.

19. The method of claim 18, wherein the one type of location is a chain business and the another type of location is an independent business.

20. The method of claim 15, wherein the ranking is based on an ease of picking up or dropping off passengers at any of the plurality of suggested locations.

21. The method of claim 15, wherein the ranking is based on whether any of the plurality of suggested locations include a designated pickup or drop off area.

22. The method of claim 1, wherein providing the one or more of the plurality of suggested locations includes providing for display an indication of why the initial destination location is unavailable.

23. The method of claim 1, wherein providing the one or more of the plurality of suggested locations includes providing for display an indication of why each of the one or more of the plurality of suggested locations is provided.
